(19) United States
(12) Patent Application Publication
(10) Pub. No.: US 2009/0070127 A1
(43) Pub. Date: Mar. 12, 2009

(54) Method and apparatus for network-based mobile device coordination

(75) Inventors: Cynthia Florkey, Fort Collins, CO (US); Ruth Schaefer Gayde, Naperville, IL (US); Todd Cartwright Morgan, Oak Park, IL (US)

Correspondence Address: FAY SHARPE/LUCENT, 1228 Euclid Avenue, 5th Floor, The Halle Building, Cleveland, OH, 44115-1843, US

(73) Assignee: Lucent Technologies Inc.

(21) Appl. No.: 11/900,197

(22) Filed: Sep. 10, 2007

(51) Int. Cl. G06Q 99/00

(52) U.S. Cl. 705/1

(57) ABSTRACT

A system and method for network-based coordination of a plurality of devices using precise timing methods is provided. The method includes registering a device for an event that utilizes precise timing. The method continues with identifying a list of devices that will participate in the event, downloading a set of tools that enable the devices to perform the event, and initiating the event for the list of devices coordinated by precise timing. The system for network-based precision includes a timing source that provides precise timing for the devices, a subscription handler that organizes the devices and event application server that provides a list of registered subscribers and initiates the group event. The method and system disclosed may be used to coordinate mobile devices for collecting data and/or provide coordination for mobile devices to display video and play audio in a group coordinated manner.

### BACKGROUND OF THE DISCLOSURE

This disclosure relates to a method and apparatus for network-based mobile device coordination. More particularly, this disclosure relates to a method and apparatus that allows users to participate in an ad-hoc group where the groups' mobile devices are used to perform certain events at precise times, both individually and collectively, in a coordinated manner.

While the disclosure is particularly directed towards telecommunication coordination in the cellular communications network and will be thus described with specific reference thereto, it will be appreciated that the disclosure may have usefulness in other fields and applications. For example, this disclosure may be used in a variety of services that allow for different types of devices to act in a coordinated manner, using precise timing in the satellite network, Plain Old Telephone Service (POTS) network, Wi-Fi network, etc.

By way of background, service providers often attempt to offer different services that generate revenue. Many trends are leaning towards the entertainment services, especially services directed towards the youth market. While most entertainment services are geared towards individuality, there are many factors that demonstrate that there is a desire for group coordination. However, cell phones, which are generally used for a variety of entertainment purposes, are limited to single users or, at most, loosely coordinated group interactions, e.g. text/Short Messaging System (SMS) messaging.

Currently in the industry there is no effective way to deliver revenue generating group entertainment services using the cellular network. Furthermore, there is no coordination in place for these devices that would have the ability to host applications beyond the entertainment sector. Furthermore, there is no current system in the industry that will allow users to participate in ad-hoc groups where their phones could perform certain functions at precise times, either individually or collectively, in a coordinated manner.

Therefore, there is a need in the industry to provide a network based system that utilizes precise timing in order to create coordinated interactions that go beyond text messaging and the like. There is further need in the industry to provide precision coordination that exists for more sophisticated end user services, which otherwise could not be delivered.

The present disclosure contemplates a new and improved system and method that resolves the above-referenced difficulties and others.

### SUMMARY OF THE DISCLOSURE

A method and apparatus for network-based coordination of a plurality of devices, using precise timing methods is provided. The disclosure will allow for particular embodiments that offer entertainment services for a community of devices to participate in group activities in a coordinated manner. This disclosure enables a wide variety of services. These services may include still image/video collection with video locations and timestamping, coordinated timing of sound effects in movies, concerts, and sporting events, and/or synchronizing an ad-hoc group of mobile devices that may play video and sound clips with coordinated timing.

In one aspect of the disclosure, a method for network-based coordination using precise timing includes registering a device for an event that utilizes precise timing, identifying a listing of devices that will participate in the event; downloading a set of tools that enables the device to perform the event, and initiating the event for the list of devices coordinated by precise timing.

In accordance with another aspect of the present disclosure, the method includes providing a check-in mechanism for the event.

In accordance with another aspect of the present disclosure, the method includes that providing a check-in mechanism for the event includes providing a check-in kiosk.

In accordance with another aspect of the present disclosure, the method includes that providing a check-in mechanism for the event includes providing a web interface.

In accordance with another aspect of the present disclosure, the method includes collecting end data from the event.

In accordance with another aspect of the present disclosure, the method includes that registering a mobile device includes collecting the physical location of the mobile device during the event.

In accordance with another aspect of the present disclosure, the method includes creating a permanent profile for the event.

In accordance with another aspect of the present disclosure, the method includes de-registering the mobile device when a de-registration occurrence takes place.

In accordance with another aspect of the present disclosure, the method includes stopping the event when the event has reached an end point.

In accordance with another aspect of the present disclosure, the method includes that the precise time for the event is derived from a common source.

In accordance with another aspect of the present disclosure, a system for network-based precision time and coordination includes a timing source that provides precise timing for mobile devices that participate in a group event, a subscription handler that organizes the plurality of mobile devices that participate in the group event into a community, and an event application server configured to provide a list of registered subscribers to the subscription handler and initiates the group event for the community, utilizing precise timing.

In accordance with another aspect of the present disclosure, the system includes that the subscription handler be configured to organize the plurality of mobile devices into subgroups, based at least in part on the mobile device's capabilities.

In accordance with another aspect of the present disclosure, the system includes a short messaging system server configured to send a short message which acts as a directive for the devices that are within an event area.

In accordance with another aspect of the present disclosure, the system includes that the group event includes the plurality of mobile devices capturing images.

In accordance with another aspect of the present disclosure, the system includes a kiosk configured to allow a mobile device user to check-in before the event.

In accordance with another aspect of the present disclosure, a system for precise coordination of a set of mobile devices within a community of interest for a precise time event, comprises a registration module configured to compile a plurality of mobile devices' information where the set of mobile devices are configured to register with the registration module for a precise timed event and an event application module configured to execute the precise timed event for the set of mobile devices in real time.

In accordance with another aspect of the present disclosure, the system includes that the precise timed event includes that the set of mobile devices play coordinated audio at precise times.

In accordance with another aspect of the present disclosure, the system includes a scheduling module that is configured to divide the registered mobile devices into sub-groups and assign various tasks to each sub-group.

In accordance with another aspect of the present disclosure, the system includes that the various tasks are assigned based, at least in part, on each mobile devices' capabilities.

In accordance with another aspect of the present disclosure, the system includes a collection module configured to collect and authenticate data from the set of mobile devices and attach location information for forwarding to an associated database.

### DESCRIPTION OF THE DRAWINGS

The presently described embodiments exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall communications network, including the subscription handler, an event application server, a plurality of mobile devices, and a timing source.

FIG. 2 is a flow chart illustrating one of the embodiments of the network-based coordination system according to the present disclosure.

FIG. 3 is a flow chart illustrating another embodiment of the network-based coordination system according to the present disclosure.

### DETAILED DESCRIPTION

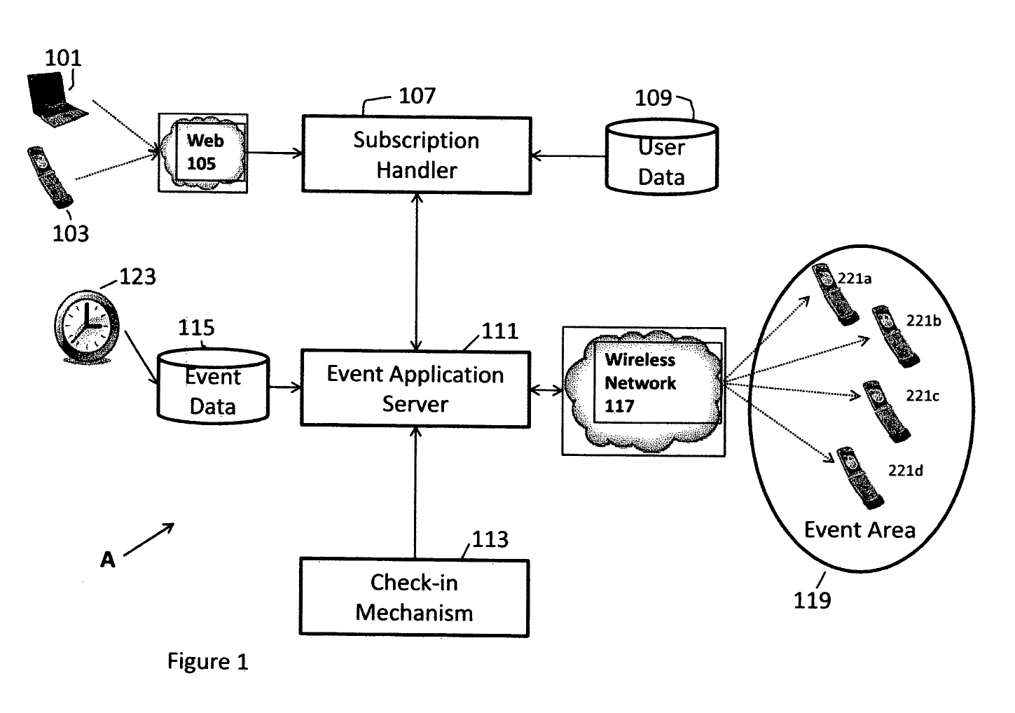

Referring now to the drawings wherein the showings are for purposes of illustrating the disclosed embodiments only and not for purposes of limiting the same. FIG. 1 provides an overall view of the system into which the present disclosure may be incorporated. A communications infrastructure A is shown. The communications infrastructure A includes a system administrator's device, e.g. a laptop 101, a system administrator's mobile device 103, a web network 105, a subscription handler 107, user data 109, an event applications server 111, check-in mechanism 113, event data 115, the wireless network 117, a plurality of mobile devices 121a through 121d, inside of the event area 119, and a timing source 123. It should be understood that this represents but one embodiment of the communications network infrastructure A. The present disclosure could be incorporated in a variety of communication network configurations.

In operation, as described in greater detail below, the presently described embodiments are directed towards a network based coordination for a plurality of mobile devices using precise timing methods. In this sense, the disclosure describes a network-based system which will allow for a community of mobile devices to coordinate a variety of events using precise timing methods. This system will allow for an ad-hoc group of mobile devices to download and play media with coordinated, precise timing. This system will also allow for a variety of embodiments that deliver entertainment services. These services will allow for precise timing coordination between a group of mobile devices in a community.

Still referring to FIG. 1, the system includes a system administrator's laptop 101 and mobile device 103. These devices are in communication with a subscription handler 107 through the internet 105. Through a registration process user data 109 is communicated to the subscription handler 107. Event data 115, including a precise time derived from a timing source 123, is compiled by the event application server 111. The event application server 111 also receives information from a check-in mechanism 113. The event application server 111 is also in communication with the subscription handler 107 in order to access the user data 109. Finally, the event application server 111 is in communication with the wireless network 117 in order to access a plurality of mobile devices 221a-d. This group of mobile devices is in a community. FIG. 1 shows this community within an event area 119.

Continuing on with FIG. 1, this embodiment includes a laptop 101 and a mobile device 103 as the system administrator's user equipment. However, other equipment, besides a laptop and a mobile device may used to administer this event. For example, a desk top computer, a PDA device, a land line telephone, etc. may be substituted. Any device that has access to the web or a web server may act as the system administrator device. These devices alone or in conjunction may be used in order to administer the event.

Typically, administration will take place through the internet. However, other media may be used in order to access the other elements. For example, the intranet or a wireless network may be used as a conduit in order to access the other elements of this disclosure. This embodiment shows the web 105 as the means in which to access the other elements.

The subscription handler 107 is useful to organize a group of mobile devices 221a-d that will participate in a group event. This group will be organized into a community of users through the subscription handler 107. The community, as described in greater detail below, may be organized in many different ways depending on the event. The subscription handler 107 may also be used to organize the mobile devices 221a-d into subgroups. The arrangement of the subgroups may also depend on a variety of factors. In one embodiment, the factors include the mobile device's capability. In this sense, the subscription handler 107 may find a mobile device 221a that is capable of playing notes, for music related event, that most mobile devices are not capable of playing. In this embodiment, the mobile device 221a may be used for that specific purpose.

FIG. 1 shows that user data 109 is communicated to the subscription handler 107. This user data 109 may be used to assist in the grouping of the individual mobile devices 221a-d. This user data 109 may also include information such as the physical location of each mobile device in the community 119. User data 109 may also include information such as the capabilities of each mobile device 221a-d. In some embodiments, user data 109 includes information that will help authenticate and time stamp data is collected from a mobile device 221. It may also assist in attaching location information of a mobile device. This may be accomplished by Global Position System (GPS) configuration, triangulation based on signal strengths, or any other method of locating the approximate geo-location of a mobile device known in the art.

Once a mobile device is registered through the subscription handler 107, a check-in mechanism 113 may be used to check-in a mobile device 221. This check-in mechanism may include a kiosk. The check-in mechanism, in other embodiments, includes a web page or interface in which a user may check-in online. In other embodiments, check-in is accomplished through Radio Frequency (RF) connections. For example, if the event is to take place in a concert hall, when a user walks through a metal detector, the metal detector may include a device that can sense the presence of a mobile device. In this form, the mobile device may be identified through its Electronic Serial Number (ESN). In another example, when a user places the cell phone adjacent to an RF sensor, the unit will be checked-in for the event. In another embodiment, Blue Tooth technology is used to check-in a mobile device. In any form, the event may require that a mobile device 221 checks in before the event to ensure that user is present and wishes to participate.

Both the subscription handler 107 and check-in mechanism 113 are in communication with the event application server 111. The event application server 111 provides a list of checked-in subscribers to the subscription handler 107. Because the event application server 111 has access to the information that details who has checked-in, the event application server 111 may tailor instructions to the mobile devices 221a-d based on the attendance. The application server 111 may be configured to download appropriate instructions to the mobile devices 221a-d after registration has completed. These downloaded tools may be used during the event in order that the mobile devices 221a-d will be able to effectively perform the event.

The event application server 111 uses the event data 115 in order to configure which tools should be downloaded to which mobile devices 221a-d. When the event is scheduled to begin, the event applications server 111 will initiate the event at the precise time.

A timing source 123 will provide precise timing for the event so that the mobile devices 221a-d may participate in the group event. Because the event will utilize precise timing, all participating mobile devices 221a-d will draw their scheduling from the timing source 123. The timing source 123 will therefore dictate when the event begins once the event application server 111 initiates the event. The precise timing may include various concurrent interactions. Wherein, each user coordinates the event in perfect synchronization with every other user.

As an example of precise timing in the CDMA embodiment, the mobile devices' 221a-d notion of absolute time is considered accurate to within a few microseconds. The timing is based on the mobile device's 221a power up sequence, in which the device 221a first finds the pilot signal from the cell site, and then finds the “sync” channel, which includes the timezone of the cell site and the number of leap seconds that have elapsed since “the beginning of time”, which for GPS is midnight on Jan. 6, 1980. The accuracy of this timing information is based on GPS signals received at the cell site. This synchronization process is repeated by the mobile device 221a at various other points, e.g., after a call completes. Proper synchronization is a fundamental element and is useful for the devices to work as mobile phones.

It should be noted that in other embodiments a human administrator may dictate when the event application server 111 will start the event based on the timing source 123. For example, in one embodiment, the event will take place after a football team scores a touchdown. In this embodiment, the human administrator notes when a touchdown is scored and will dictate that the event application server 111 should immediately initiate the football team's fight song on all subscribed devices, using the timing source 123. The human administrator may also initiate the event precisely two minutes after the extra point attempt, once the game has returned from commercial.

The wireless network 117 may be used in order to facilitate communication between the event application server 111 and the group of mobile devices 221a-d. However, it should be noted that other means may be used in order to facilitate this communication. For example, the intranet, a service provider network, etc. may be used as a communication means to a variety of end user devices.

In the embodiment shown in FIG. 1, the mobile devices 221a-d are all in the event area 119. This event area may be physical location such as a concert hall or a football stadium. Although FIG. 1 shows that all of the mobile devices 221a-d are inside of the event area 119, this is but one embodiment. The participating group need not be in the same physical location. In other embodiments, anybody who signs up for this particular service may participate in the event, regardless of location.

Continuing on with FIG. 1, four mobile devices 121a-d are shown as being in the group. It should be noted that this disclosure should not be limited to only including groups of four mobile devices. Any number of mobile devices may participate in this event.

At registration, each mobile device may include with it, information including its capabilities. For example, if one mobile device is capable of playing a special tone that other mobile devices are incapable of playing, this information may included in registration. Because different mobile devices have different capabilities, depending on their manufacturer, etc., the subscription handler 107 may group the mobile devices into groups optimizing the event.

Registration information may also include where the mobile device will be physically positioned during the event. For example, if the event includes playing tones in a concert hall, it may be beneficial to know where each mobile device user is going to be seated in the auditorium. In this sense, in one embodiment, the left side of the auditorium may play the oboe part. The right side of the auditorium may participate in playing in the flute part, and so forth. Therefore, this seating information may be included in the registration information.

These mobile devices 221a-d may also be grouped into subgroups. Each of the subgroups may be used to participate in a different part of the event. Again using the concert embodiment of the disclosure as an example, some mobile devices may play the percussion part of the concert, while others play the woodwind parts. Still others may perform a string passage and possibly all mobile devices will participate in the brass finale of the performance.

FIG. 1 presents but one embodiment of the disclosure. Implementation of these various network elements may depend on how the system is used. Different hardware and software configurations may be used and still fit within the scope of this disclosure. For example, the check-in mechanism 113 may be an extension of the event application server 111. It may not necessarily be a separate entity. A similar situation exists for the subscription handler 107 which may also not be a separate entity from the event application server 111.

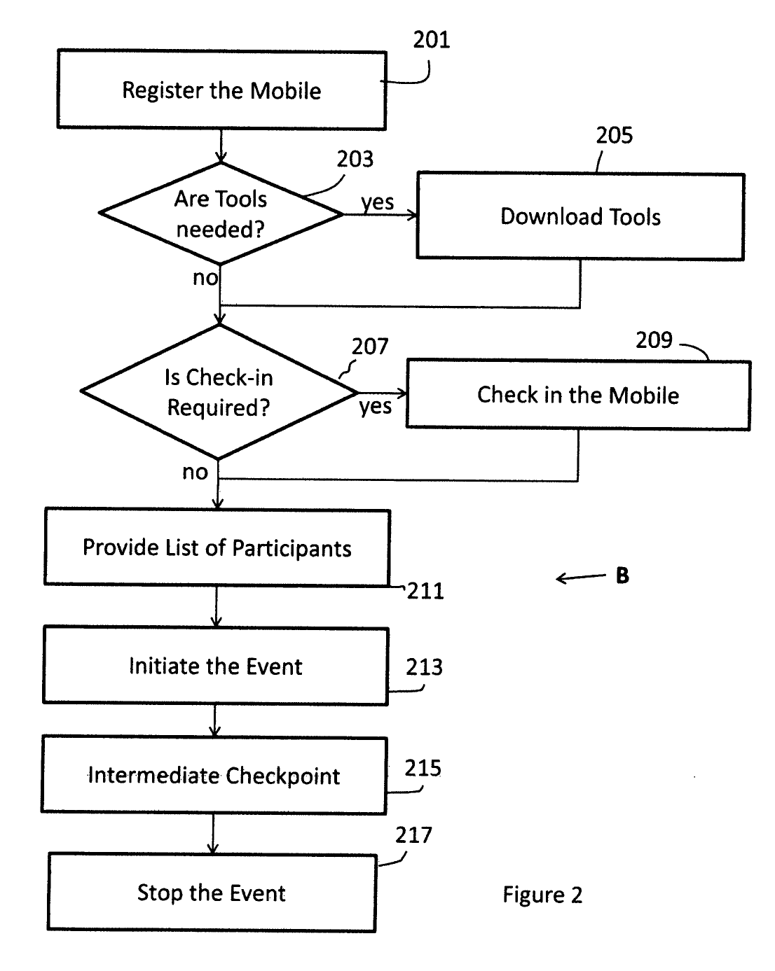

Now referring to FIG. 2 which is a flow chart illustrating one embodiment of the method according to the present disclosure. This figure generally shows the steps included in the services related to the mobile devices displaying images and/or playing audio. This flow chart B shows embodiments that allow for mobile devices to play different musical parts, coordinated timing similar to a cell phone orchestra. This flow chart B may also be used as an example of a service for movie goers cell phones to download and play sound effects (e.g. screams) with timing coordinated to the action on a screen. This flowchart B may also be used as an enhanced service for an ad-hoc group of individuals to download and play music clips with timing coordinated so that the mobile devices play music at a precise instant. This will enable “bebopping” to the beat in sync. This service may also allow for individuals in a crowded football stadium to all have their mobile devices play tones or video, e.g. the college fight song, all at the same time. This embodiment will also allow for a service where a rally or public event organizer may desire for citizens with a common point of interest to download and play clips or chants in a coordinated manner, e.g. in a parade or public assembly.

Still referring to FIG. 2, the method begins with registering the mobile at step 201. The mobile devices 221a-d may communicate with the subscription handler (107, FIG. 1) for the service to register. At this point, the mobile devices may be assigned to particular subgroup identification, possibly based on the type of user device or the location of their seat in a concert hall. This user information is downloaded to the event application server (111, FIG. 1).

Registering the mobile may include creating a permanent profile. This can assure that user is registered whenever this event, or a similar event, occurs. A permanent profile may be especially useful in annual, or otherwise repeating, events. Creating a permanent profile may also assist in client recognition for the mobile device.

FIG. 2 continues with the inquiry of whether tools are needed (at step 203). If tools are needed, tools may be downloaded (at step 205). During or after the subscription transaction, the mobile devices (221a-d, FIG. 1) may need downloaded ring tones, digital sound clips or videos in order to fully participate in the event.

The method continues with a check-in inquiry (at step 207). Some events may require a check-in for each participating mobile. For example, if the event includes playing ring tones at a concert, one may register their mobile device when they purchase tickets. However, if the concert goer is not able to make the concert because they were stuck in traffic, that concert goer would not check-in at the concert venue. In this sense, the system administrator may require check-in once the concert goer arrives at the concert hall to ensure all participating mobile devices are present.

If check-in is required, the method will continue with checking in the mobile (at step 209). Check-in may be accomplished through a variety of ways. In one embodiment, there is a physical kiosk located at the event venue. In other embodiments, check-in is automatic once the registered mobile device enters the event venue. In another embodiment, check-in takes place after a certain time via the internet. In this embodiment, a user may log on to a web page at some point after the mobile is registered and check-in the mobile closer to the event's start time. Check-in could include sending a SMS message to a server showing that the user wishes to participate. In this form, the system administrator can be relatively sure that the checked-in mobile device will participate in the event.

The method continues with providing a list of participants (at step 211). The event application server 111 provides a list of checked-in subscribers to the subscription handler 107. The subscription handler 107 may then download the user device profiles including information related to the musical capabilities of the devices. Then, in this step, the relevant concert goer participant information is downloaded from the subscription handler 107 and the check-in mechanism 113 (if necessary) to the event application server 111. At this point, the relevant participant information derived from user data (109, FIG. 1) is downloaded. This information may include groups, participants, available devices and ring tones, etc. In this sense, the event may be initiated with each mobile device playing its particular part.

The method continues with the initiation of the event (at step 213). Once the event start time has been reached, the application server 111 may send out an initiation time message to denote the precise moment at which the event is set to commence.

The method continues with an intermediate check point (at step 215). Instructions may be issued in order to assist in keeping the phones in sync during the event. For example, an instruction could include the command that states at a time of X, the measure Y should be played. In this form, a mobile device 221d can check to see if it is in the right place during the event. Any device that is ahead or behind may jump to the right place as needed.

Other check points may include a battery status report. In this form the application server 111 may reassign a mobile device to a different part as needed. For example, if mobile device 221c is to play the oboe part and its mobile device has reported a battery level as low, the application server 111 may reassign that part to mobile device 221b, just before the big oboe solo in real time. The application server 111 may also check for deregistration occurrences, such as if a user has turned their mobile device off. In this form, the event application server 111 may keep a current status on all mobile devices participating in the event.

The method concludes with stopping the event (at step 215). If the event reaches an end point, the application server 111 may stop the event. For example, if the event is a social action rally, the system administrator may find it necessary to stop the event, e.g., chanting, if the event gets out of control. In another embodiment, the system administrator may choose to stop a football team's fight song because the opposing side has returned the kick off for a touchdown.

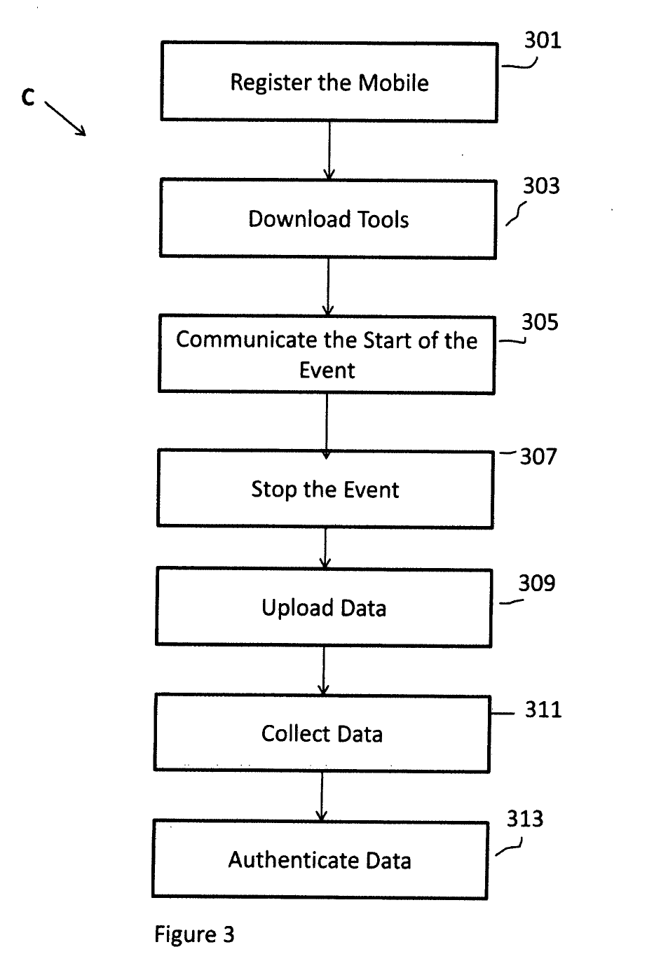

FIG. 3, is a flow chart illustrating another embodiment of the method according to the present disclosure. This figure generally shows the steps included in the services related to the mobile devices capturing images and videos of an event. These images and videos may be collected with time stamp and geolocation stamps with precise timing.

Still referring to FIG. 3, the method begins with registering the mobile (at step 301). Similar to FIG. 2, mobile devices may be registered through a communication with a subscription handler (107, FIG. 1).

The method continues with downloading tools (at step 303). Tools will generally be used for various device capabilities, e.g. camera, MIDI capabilities, blue tooth, GPS operating systems, CPU speed, memory, etc. As noted above, the subscriber information may become part of a permanent profile used for multiple events.

In this embodiment, an event may happen at a moment's notice or be planned. For example, the event could be a disaster, such as a terrorist attack, an earthquake, a hurricane or bridge collapse. In this event, an administrator may send an SMS message communicating the start of an event and all registered mobile devices may be instructed to take pictures in order to record the event (at step 305). In another embodiment, the event is related to art and the artist chooses a moment in time around a certain city. At a precise time all mobiles are instructed to take a picture at different points around a subject city at a precise time. In this form, the communication for the start of the event is set and all participants take an active role.

At a certain point an administrator may communicate that the event should stop (at step 307). At this point the event application server 111 may issue a directive to the devices that at a specific time the event should stop. In another aspect, the event will come to a natural stopping point and no stop directive is needed.

At some point after the event has come to a stop, the event application server 111 may issue a directive to upload all the data that was collected from the mobile devices (at step 309). This information may be sent to a database for temporary or permanent storage.

Once the data has been uploaded, the data can then be collected (at step 311) and authenticated (at step 313). The data may be time stamped and sorted according to when and where the data was collected. This is all possible by using precise timing techniques. Once all the data is collected and authenticated a true picture of the events can be formed with proper analysis.

Advantageously, this disclosure can leverage the fact that Code Division Multiple Access (CDMA) has precise timing derived from a satellite based timing source 123, FIG. 1. The timing source 123 is generally used for spread-spectrum voice. However, through this disclosure, the event application server 111 may issue a variety of directives with confidence that all mobile devices will act on the directive at a precise instant in time, even when the network presents varying degrees of delay to broadcast future instructions to the devices. This disclosure utilizes absolute time to its advantage in the above referenced steps and methods.

The above described embodiments that were shown in FIGS. 2 and 3 present but one embodiment of the above-described disclosure. Implementation of these various network elements depend on how the system is used. These functions may be performed by some or all of the network elements in conjunction or separate from one another and variations may exist. Description of these embodiments is not meant to limit the claims but instead show how some embodiments of the method may be used.

The above description merely provides a disclosure of particular embodiments of the invention and is not intended for the purpose of limiting the same thereto. As such, the invention is not limited to only the above-described embodiments. Rather, it is recognized that one skilled in the art could conceive alternative embodiments that fall within the scope of the invention.

We claim:

1. A method for network based coordination of a plurality of devices using precise timing methods comprising:
registering a device for an event that utilizes precise time;
identifying a listing of devices that will participate in said event;
downloading a set of tools that enables said device to perform said event; and
initiating said event for said list of devices coordinated by precise timing.

2. The method according to claim 1, further comprising providing a check-in mechanism for said event.

3. The method according to claim 2, wherein providing a check-in mechanism for said event includes providing a check-in kiosk.

4. The method according to claim 2, wherein providing check-in mechanism for said event includes providing a web interface.

5. The method according to claim 2, wherein providing check-in mechanism for said event includes allowing for check-in via short messaging.

6. The method according to claim 1, further comprising collecting end data from said event.

7. The method according to claim 1, wherein said registering a device includes collecting the physical location of said device during said event.

8. The method according to claim 1, further comprising creating a permanent profile for said event.

9. The method according to claim 1, further comprising deregistering said device when a deregistration occurrence takes place.

10. The method according to claim 1, further comprising stopping said event when said event has reached an end point.

11. The method according to claim 1, wherein said precise time for each said device is derived from a common source.

12. The method according to claim 1, further comprising performing an intermediate checkpoint after said event has been initiated.

13. The method according to claim 1, wherein said device is a mobile device.

14. A system for network based precision timing coordination of a set of devices comprising:
a timing source that provides precise timing for a plurality of devices that participate in a group event;
a subscription handler that organizes said plurality of said devices that participate in said group event into a community; and
an event application server configured to provide a list of registered subscribers to said subscription handler and initiates said group event for said community utilizing precise timing.

15. The system according to claim 14, wherein said subscription handler is configured to organize said plurality of devices into sub-groups based at least in part on said device capabilities, where each subgroup performs a different function for said group event.

16. The system according to claim 14, further comprising a short messaging system server configured to send a directive short message to said registered subscribers.

17. The system according to claim 14, further comprising a short messaging system server configured to receive short message registration.

18. The system according to claim 14, wherein said group event includes said plurality of devices capturing images.

19. The system according to claim 14, further comprising a kiosk configured to allow a device user to check-in before said event.

20. A system for precision coordination of a set of mobile devices within a community of interest for a precise timed event comprising:
a registration module configured to compile a plurality of mobile devices' information where said set of mobile devices are configured to register with said registration module for a precise timed event; and
an event application module configured to execute said precise timed event for said set of mobile devices in real time.

21. The system according claim 20, wherein said precisely timed event includes that said set of mobile devices play coordinated audio at precise times.

22. The system according to claim 20, wherein said precisely timed event includes that set of mobile devices download and play video.

23. The system according to claim 20, further comprising a collection module configured to collect, authenticate and time stamp data from said set of mobile devices and attach location information for forwarding to an associated database.

24. The system according to claim 20, further comprising a scheduling module configure to divide said registered mobile devices into subgroups and assign various tasks to each subgroup.

25. The system according to claim 24, wherein said various tasks are assigned, at least in part, based upon each mobile device's capabilities.
